(19) United States
(12) Patent Application Publication
(10) Pub. No.: US 2007/0137442 A1
(43) Pub. Date: Jun. 21, 2007

(54) GRIP MEMBER FOR WRENCH

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/675,750

(22) Filed: Feb. 16, 2007

Related U.S. Application Data
(63) Continuation-in-part of application No. 10/978,592, filed on Nov. 1, 2004.

(51) Int. Cl. B25B 23/16; B25G 1/00

(52) U.S. Cl. 81/177.1

(57) ABSTRACT

A wrench includes a body having a head and a handle having a grasping section. The handle includes two opposed sidewalls and a recessed portion between the sidewalls and at least partially located in the grasping section. A mounting hole extends from a bottom wall of the recessed portion through an outer side of the grasping section. A grip member includes a raised portion engaged in the recessed portion and having a receiving hole aligned with the mounting hole. A fastener is extended through the mounting hole into the receiving hole. The combined handle/grip member has a central line of a height extending between the ends of the body. Each sidewall of the handle extends across the central line. In another embodiment, a mounting strip is provided in a slot in the grasping section and has a peg engaged in a receiving hole of the grip member.

### CROSS REFERENCE TO RELATED APPLICATION

This is a continuation-in-part application of U.S. patent application Ser. No. 10/978,592 filed Nov. 1, 2004.

### BACKGROUND OF THE INVENTION

1. Field of the Invention

The present invention relates to a grip member and, more particularly, to a grip member for a wrench.

2. Description of the Related Art

Wrenches play an important role in daily life. FIGS. 9 and 10 of the drawings illustrate a conventional wrench 40 including a head 41 on an end thereof and a handle 43 on the other end thereof. To reduce the overall weight of the wrench, the wrench 40 has a recessed portion 44 extending from the head 41 through the handle 43 made of metal, and a plastic grip member 45 is bonded by gluing to a section 42 of the recessed portion 44 in the handle 43. The bonding area between the grip member 45 and the handle 43 is planar. Further, a periphery of the handle 43 extends through an area smaller than a half of an overall periphery of the combined grip member 45/handle 43. Namely, the grip member 45 extends across a center line L of the combined grip member 45/handle 43 whereas the sidewalls of the handle 43 do not extend across the center line L. Thus, when a user grasps the combined grip member 45/handle 43 and drives a fastener, most part of the force from the hand of the user is imparted to the grip member 45, resulting in an increase in the gap between the grip member 45 and the handle 43. In some cases, the grip member 45 would disengage from the handle 43 after long-term use.

It is therefore a need in the grip member for a wrench that mitigates and/or obviates the above-mentioned problems.

### SUMMARY OF THE INVENTION

The present invention solves this need and other problems in the field of wrenches with grip members by providing a wrench including a body and a grip member. The body includes a head and a handle respectively on two ends thereof. The handle includes two opposed sidewalls and a recessed portion between the sidewalls. The handle further includes a grasping section. The recessed portion is at least partially located in the grasping section. The grip member includes a raised portion engaged in the recessed portion of the handle. The combined handle/grip member has a central line of a height extending between the ends of the body. Each sidewall of the handle extends across the central line. The driving force from the user can be effectively transmitted to the head of the body, as the sidewalls of the handle withstand most part of the driving force.

In a preferred form of the present invention, the grasping section includes a mounting hole extending from a bottom wall of the recessed portion through an outer side of the grasping section. The mounting hole includes an outer, larger section and an inner, smaller section having a diameter smaller than that of the outer, larger section. The raised portion includes a receiving hole aligned with the mounting hole of the grasping section. A fastener is extended through the mounting hole into the receiving hole and has a head received in the outer, larger section of the mounting hole. A seal is mounted in the mounting hole of the grasping section of the handle to seal the mounting hole. In the most preferred form, the seal is a ball having a diameter slightly greater than that of the mounting hole of the grasping section of the handle.

In another preferred form, the grasping section includes a slot extending from a bottom wall of the recessed portion through an outer side of the grasping section. The slot includes a length extending in a longitudinal direction of the handle and a width smaller than the length. The slot includes an outer, wider section and an inner, narrower section having a width smaller than that of the outer, wider section. The raised portion of the grip member includes a receiving hole facing the inner, narrower section of the slot of the grasping section. A mounting strip is securely mounted in the outer, wider section of the slot of the grasping section. The mounting strip includes a peg extending through the inner, narrower section of the slot of the grasping section into the receiving hole of the grip member. In the most preferred form, the grip member further includes another receiving hole facing the inner, narrower section of the slot of the grasping section and spaced from the receiving hole of the grip member. The mounting strip further includes another peg extending through the inner, narrower section of the slot of the grasping section into the other receiving hole of the grip member.

Preferably, each sidewall of the handle has a reduced height not extending across the central line at a section outside the grasping section to save material for the handle.

Preferably, the recessed portion extends across the central line of the height of the combined handle/grip member.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a perspective view of a perspective view of a first embodiment of a wrench according to the preferred teachings of the present invention.

FIG. 2 is a perspective view, partly exploded, of the wrench in FIG. 1.

FIG. 3 is a bottom perspective view of the wrench in FIG. 1.

FIG. 4 is a sectional view taken along plane 4-4 in FIG. 1.

FIG. 5 is a perspective view illustrating use of the wrench according to the preferred teachings of the present invention.

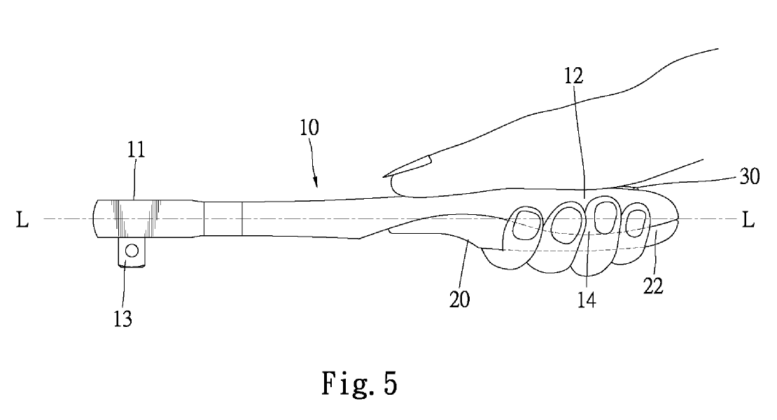

FIG. 6 is perspective view, partly exploded, of a second embodiment of the wrench according to the preferred teachings of the present invention.

FIG. 7 is a sectional view of the wrench of FIG. 6 in an assembled state.

FIG. 8 is a sectional view similar to FIG. 4, illustrating a third embodiment of the wrench according to the preferred teachings of the present invention.

FIG. 9 is a perspective view, partly exploded, of a conventional wrench.

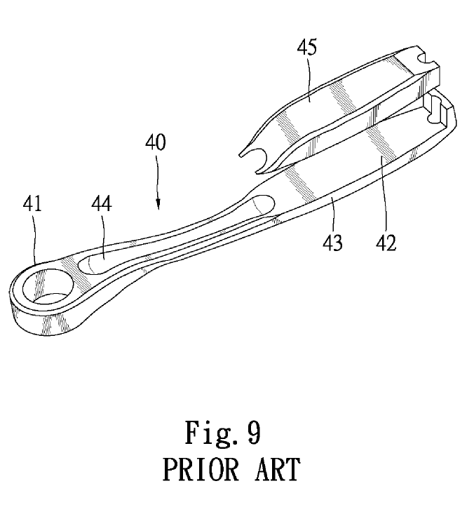

FIG. 10 is a side view of the wrench in FIG. 9.

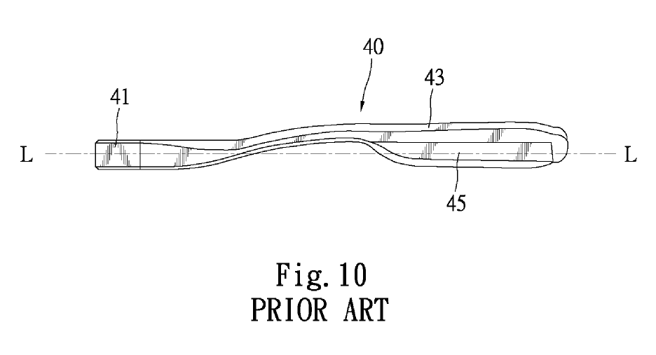

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “bottom”, “upper”, “end”, “section”, “central”, “longitudinal”, “inner”, “outer”, “height”, “width”, “length”, and similar terms are used herein, it should be understood that these terms have reference only to the structure shown in the drawings as it would appear to a person viewing the drawings and are utilized only to facilitate describing the invention.

### DETAILED DESCRIPTION OF THE PREFERRED EMBODIMENTS

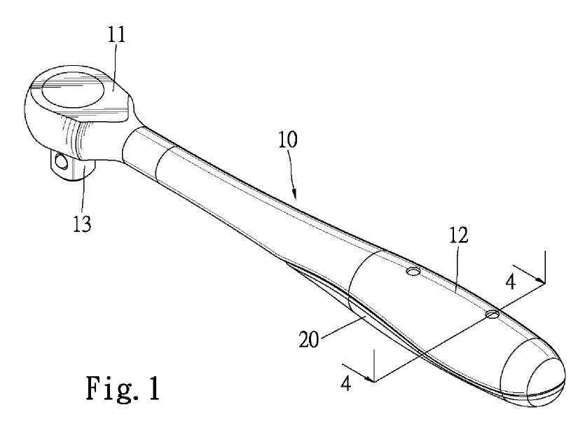

FIGS. 1 through 4 illustrate a first embodiment of a wrench according to the preferred teachings of the present invention. The wrench includes a body 10 and a grip member 20. The body 10 includes a head 11 on an end thereof and a handle 12 on the other end thereof. In this embodiment, the head 11 includes a drive column 13 for driving fasteners (not shown) such as bolts, screws, etc. Further, a mechanism (not shown) for controlling a ratcheting direction for driving the fastener and a free rotating direction not driving the fastener can be mounted in the head 11.

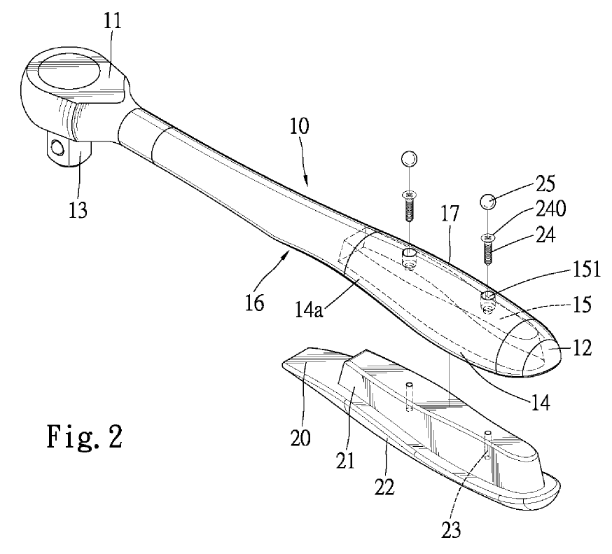

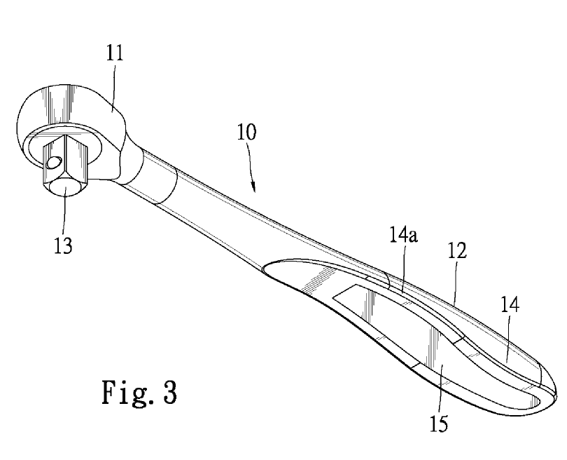

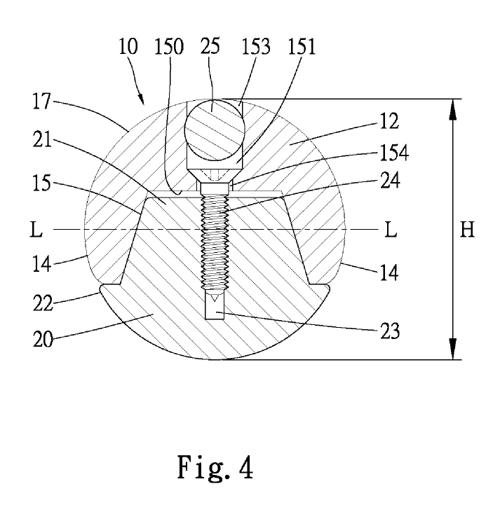

Still referring to FIGS. 1 and 2 and further to FIGS. 3 and 4, the handle 12 of the body 10 includes a perimeter 16 with two opposed sidewalls 14. The handle 12 further includes a recessed portion 15 between the sidewalls 14. As illustrated in FIGS. 2 and 4, the handle 12 includes a grasping section 17 for a user's grip. The recessed portion 15 is at least partially located in the grasping section 17. Namely, the recessed portion 15 may extend forward beyond the grasping section 17. Each of the sidewalls 14 at the grasping section 17 extends across a central line L of a height H (FIG. 4) of the combined handle 12/grip member 20. The height H of the combined handle 12/grip member 20 is between two ends of the body 10 and substantially orthogonal to a plane on which the wrench turns while driving a fastener. The grasping section 17 further includes at least one mounting hole 151 (two in this embodiment) extending from a bottom wall 150 of the recessed portion 15 through an outer side of the grasping section 17. Each mounting hole 151 has an outer, larger section 153 and an inner, smaller section 154 having a diameter smaller than that of the outer, larger section 153 (FIG. 4). Preferably, the recessed portion 15 extends across the central line L of the height H of the combined handler 2/grip 20. The recessed portion 15 in the illustrated embodiment is in a bottom side of the handle 12. In an alternative embodiment, the recessed portion 15 is defined in an upper side of the handle 12. The handle 12 may be formed by forging a metal rod.

It is noted that the sidewalls 14 at the other section (i.e., outside the grasping section 17, see section 14a) of the handle 12 may not extend across the central line L orthogonal to the height H of the combined handle 12/grip member 20. As illustrated in FIGS. 2 and 3, each sidewall 14 is curved and has a reduced height not extending across the central line L at the section 14a outside the grasping section 17. This may save more metal material of the handle 12.

The grip member 20 is made of a material that is cheaper and lighter than the metal material for the handle 12. For example, the grip member 20 can be made of polymers. The grip member 20 includes a raised portion 21 on an inner side thereof. Further, at least one receiving hole 23 (two in this embodiment) is defined in the raised portion 21. The receiving holes 23 may be screw holes.

As illustrated in FIG. 4, the grip member 20 is engaged with the grasping section 17 of the handle 12 with the raised portion 21 of the grip member 20 being engaged in the recessed portion 15. A fastener 24 (e.g., a screw) is mounted in each mounting hole 151 of the grasping section 17 of the handle 10 and extended into an associated receiving hole 23 aligned with the mounting hole 151, with the head 240 of each fastener 24 retained in the outer, larger section 153 of the mounting hole 151. A seal 25 is mounted in each mounting hole 151 to seal the mounting hole 151, providing an aesthetic appearance. In the most preferred form shown, the seal 25 is a ball with a diameter slightly greater than that of the mounting hole 151.

The grip member 20 has two opposite sidewalls 22 having curvatures corresponding to those of the sidewalls 14 of the handle 12. The sidewalls 14 and 22 are ergonomically streamlined for easy grip by the user.

As illustrated in FIG. 4, since each sidewall 14 at the grasping section 17 extends across the central line L of the height H (FIG. 4) of the combined handle 12/grip member 20, the sidewalls 14 of the handle 12 withstand most part of the driving force from the user. Since the sidewalls 14 are an integral part of the body 10, the driving force can be effectively transmitted to the head 11 of the body 10. Thus, undesired displacement of the grip member 20 is less likely to occur even after long-term use of the wrench. Disengagement of the grip member 20 from the body 10 is avoided.

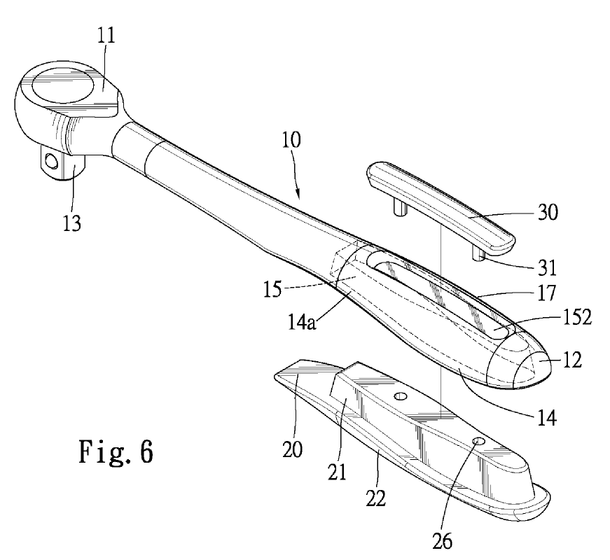

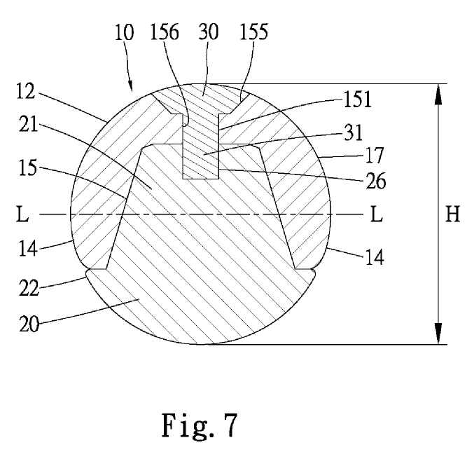

FIGS. 6 and 7 illustrate a second embodiment according to the preferred teachings of the present invention. The elements of the second embodiment identical to those in the first embodiment of FIGS. 1 through 4 are labeled with identical reference numbers. Only the differences between the embodiments are described to avoid redundancy. Specifically, the grasping section 17 includes a slot 152 extending from a bottom wall 150 of the recessed portion 15 through an outer side of the grasping section 17. Furthermore, the slot 152 extends a longitudinal direction of the handle 12 and has a length smaller than that of the recessed portion 15 in the longitudinal direction of the handle 12. The width of the slot 152 is smaller than the length of the slot 152. Further, the slot 152 includes an outer, wider section 155 and an inner, narrower section 156 having a width smaller than that of the outer, wider section 155. In the most preferred form shown, the raised portion 21 of the grip member 20 includes two receiving holes 26 facing the inner, narrower section 156 of the slot 152 of the grasping section 17 and spaced from each other. A mounting strip 30 is securely mounted in the outer, wider section 155 of the slot 152. The mounting strip 30 includes two pegs 31 respectively engaged in the receiving holes 26. The pegs 31 have an outer diameter equal to the width of the inner, wider section 156 of the slot 152. The mounting strip 30 provides added value to the wrench while preventing disengagement of the grip member 20. The mounting strip 30 and the grasping section 17 of the handle 12 can be joined together by any suitable methods including but not limited to high frequency welding.

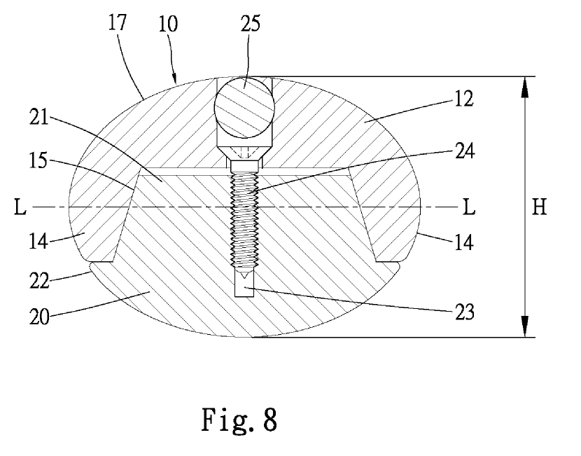

FIG. 8 illustrates a third embodiment of the invention, wherein the handle 12 and the grip member 20 are substantially elliptic after assembly.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A wrench comprising:
a body comprising a head on an end thereof and a handle on another end thereof, with the handle including two opposed sidewalls and a recessed portion between the sidewalls, with the handle further including a grasping section, with the recessed portion being at least partially located in the grasping section, with the grasping section including a mounting hole extending from a bottom wall of the recessed portion through an outer side of the grasping section;
a grip member including a raised portion engaged in the recessed portion of the handle, with the raised portion including a receiving hole aligned with the mounting hole of the grasping section; and
a fastener extending through the mounting hole into the receiving hole of the raised portion, thereby securely coupling the grip member with the handle, with the fastener including a portion securely received in the mounting hole of the grasping section; with the combined handle/grip member having a central line of a height extending between the end and the other end of the body, and with each said sidewall of the handle extending across the central line.

2. The wrench as claimed in claim 1, with the mounting hole including an outer, larger section and an inner, smaller section having a diameter smaller than that of the outer, larger section, and with the fastener including a head received in the outer, larger section of the mounting hole.

3. The wrench as claimed in claim 1, with the wrench further including a seal mounted in the mounting hole of the grasping section of the handle to seal the mounting hole.

4. The wrench as claimed in claim 3, with the seal being a ball having a diameter slightly greater than that of the mounting hole of the grasping section of the handle.

5. The wrench as claimed in claim 1, with each said sidewall of the handle having a reduced height not extending across the central line at a section outside the grasping section.

6. The wrench as claimed in claim 1, with the recessed portion extending across the central line of the height of the combined handle/grip member.

7. The wrench as claimed in claim 2, with the recessed portion extending across the central line of the height of the combined handle/grip member.

8. The wrench as claimed in claim 3, with the recessed portion extending across the central line of the height of the combined handle/grip member.

9. The wrench as claimed in claim 4, with the recessed portion extending across the central line of the height of the combined handle/grip member.

10. The wrench as claimed in claim 5, with the recessed portion extending across the central line of the height of the combined handle/grip member.

11. A wrench comprising:
a body comprising a head on an end thereof and a handle on another end thereof, with the handle including two opposed sidewalls and a recessed portion between the sidewalls, with the handle further including a grasping section, with the recessed portion being at least partially located in the grasping section, with the grasping section including a slot extending from a bottom wall of the recessed portion through an outer side of the grasping section, with the slot including a length extending in a longitudinal direction of the handle and a width smaller than the length;
a grip member including a raised portion engaged in the recessed portion of the handle, with the raised portion including a first receiving hole facing the slot of the grasping section; and
a mounting strip securely mounted in the slot of the grasping section, with the mounting strip including a first peg extending into the first receiving hole of the grip member;
with the combined handle/grip member having a central line of a height extending between the end and the other end of the body, with each said sidewall of the handle extending across the central line.

12. The wrench as claimed in claim 11, with the slot including an outer, wider section and an inner, narrower section having a width smaller than that of the outer, wider section, with the first receiving hole of the raised portion facing the inner, narrower section of the slot of the grasping section, with the mounting strip being securely mounted in the outer, wider section of the slot of the grasping section, with the first peg of the mounting strip extending through the inner, narrower section of the slot of the grasping section into the first receiving hole of the grip member.

13. The wrench as claimed in claim 11, with each said sidewall of the handle having a reduced height not extending across the central line at a section outside the grasping section.

14. The wrench as claimed in claim 12, with each said sidewall of the handle having a reduced height not extending across the central line at a section outside the grasping section.

15. The wrench as claimed in claim 11, with the recessed portion extending across the central line of the height of the combined handle/grip member.

16. The wrench as claimed in claim 12, with the recessed portion extending across the central line of the height of the combined handle/grip member.

17. The wrench as claimed in claim 13, with the recessed portion extending across the central line of the height of the combined handle/grip member.

18. The wrench as claimed in claim 11, with the length of the slot being smaller than that of the recessed portion in the longitudinal direction of the handle.

19. The wrench as claimed in claim 12, with the grip member further including a second receiving hole facing the inner, narrower section of the slot of the grasping section and spaced from the first receiving hole of the grip member, and with the mounting strip further including a second peg extending through the inner, narrower section of the slot of the grasping section into the second receiving hole of the grip member.

20. The wrench as claimed in claim 16, with the grip member further including a second receiving hole facing the inner, narrower section of the slot of the grasping section and spaced from the first receiving hole of the grip member, and with the mounting strip further including a second peg extending through the inner, narrower section of the slot of the grasping section into the second receiving hole of the grip member.
